(19) United States
(12) Patent Application Publication
(10) Pub. No.: US 2024/0123340 A1
(43) Pub. Date: Apr. 18, 2024

(54) HAPTIC FINGERPRINT OF USER'S VOICE

(71) Applicant: Sony Interactive Entertainment Inc., Tokyo (JP)

(72) Inventors: Mahdi Azmandian, San Mateo, CA (US); Victoria Dorn, San Mateo, CA (US)

(21) Appl. No.: 18/046,891

(22) Filed: Oct. 14, 2022

(51) Int. Cl. A63F 13/285; A63F 13/215; A63F 13/87; H04R 3/04

(52) U.S. Cl. CPC A63F 13/285; A63F 13/215; A63F 13/87; H04R 3/04; A63F 2300/1037

(57) ABSTRACT

To enhance the sensory experience of voice, in some cases at a later time than the speech was spoken to enable reliving emotions and experiences, vocal sounds captured by a microphone are processed by a computer game controller API. The API plays back the vocal sounds at a later time in haptic format on the controller. The vocal sounds may be computer game dialogue, party chat, or vocal sounds of the user as demanded by the computer game.

### FIELD

The present application relates generally to haptic fingerprints of user's voices.

### BACKGROUND

As understood herein, computer simulations such as computer games can entail a significant amount of vocal audio, both from dialog in the game and among players using chat.

### SUMMARY

As further understood herein, understanding and enjoyment of computer simulation-related vocal audio can be enhanced.

Accordingly, an apparatus includes at least one processor configured to receive voice audio related to play of at least one computer simulation, and actuate at least one haptic generator using the voice audio.

In example embodiments, the voice audio can include dialog computer simulation and/or chat of at least one player of the computer simulation.

In some implementations, the haptic generator includes linear actuator such as a linear resonant actuator with a voice coil coupled to a moving mass that has a magnetic element.

In non-limiting embodiments, the processor can be configured to actuate the haptic generator using the voice audio as the voice audio is played on at least one speaker. In other non-limiting embodiments, the processor can be configured to actuate the haptic generator using the voice audio after the voice audio is played on at least one speaker.

In another aspect, a method to enhance the sensory experience of voice includes capturing vocal sounds related to a computer simulation, and activating at least one haptic generator in at least one computer simulation component using the vocal sounds.

In another aspect, a device includes at least one computer storage that is not a transitory signal and that in turn includes instructions executable by at least one processor to receive signals representing speech related to at least one computer simulation, and use the signals to activate at least one haptic generator.

In certain embodiments of this last aspect, the instructions may be executable to process the signals to conform to characteristics of the haptic generator, such by optimizing the signals for a frequency response of the haptic generator. This may be done by removing portions of the signals through use of an equalization filter or a shelving filter.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system consistent with present principles;

FIG. 3 illustrates example logic in example flow chart format for playing a haptic fingerprint of vocal audio from a computer simulation;

FIG. 4 illustrates example logic in example flow chart format for playing a haptic fingerprint of vocal audio from chat of players of a computer simulation;

FIG. 5 illustrates a screen shot of an example user interface (UI) consistent with present principles; and

FIG. 6 illustrates an example haptic actuator consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

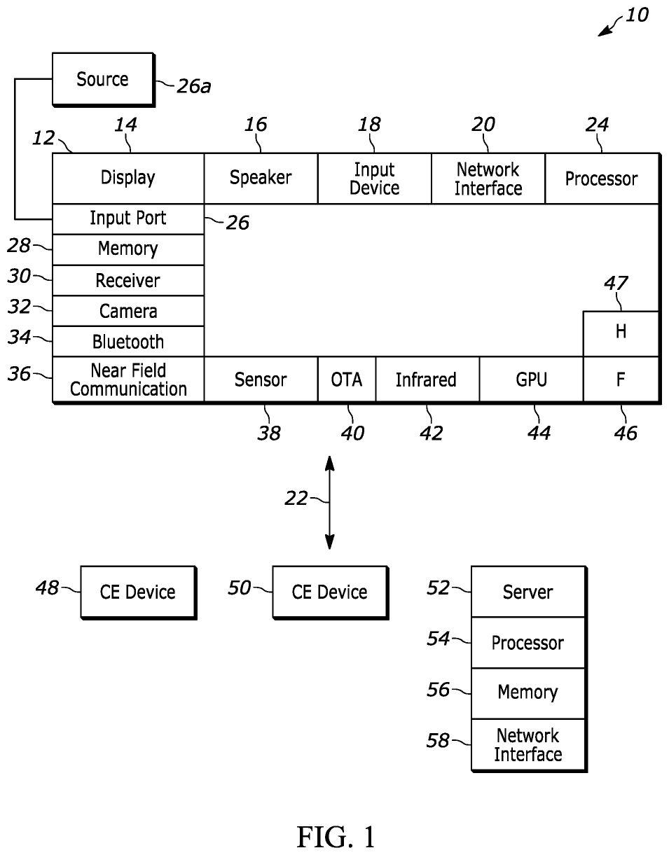

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

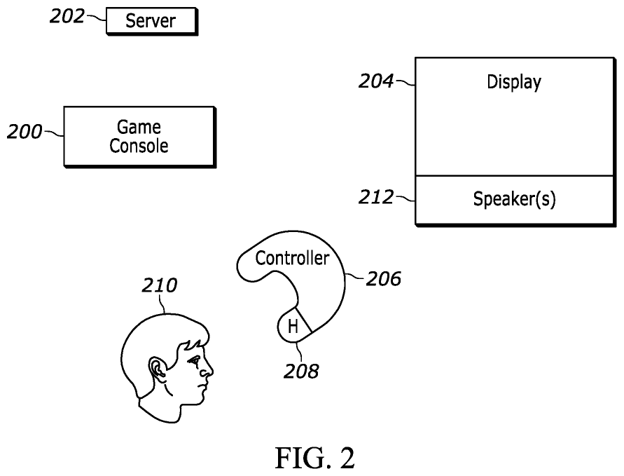

Refer now to FIG. 2. A computer simulation such as a computer game may be sent from a computer game console 200 or a computer game server 202 to a display device 204 such as a TV for presentation of the computer simulation under control of one or more computer simulation controllers 206, such as but not limited to a PlayStation® controller or other controller.

One or more haptic generators 208 may be provided on the controller 206, which can be operated by a player 210 to control presentation of the computer simulation. Audio sourced from the game console 200 or server 202 is played on one or more speakers 212 of a speaker system. The elements of the system shown in FIG. 2 can incorporate some or all of the appropriate devices and components described above in reference to FIG. 1.

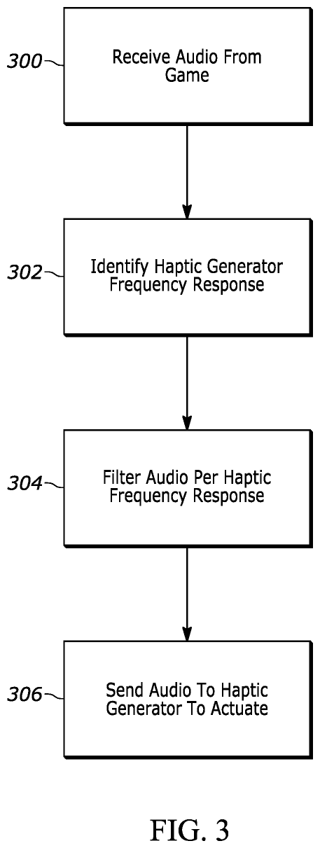

FIG. 3 illustrates that to enhance the sensory experience of voice audio that is received at block 300 from a computer simulation as demanded audio, in some cases at a later time than the speech is played on an audio speaker to enable reliving emotions and experiences, a computer game controller API or other control component accesses characteristics of the haptic generator 208 shown in FIG. 2 at block 302 in FIG. 3. If desired, at block 304 the voice audio may be filtered to conform to the characteristics of the haptic generator.

For example, the voice audio can be optimized for the frequency response of the haptic generator, e.g., by removing sounds that won't vibrate well through use of an equalization filter or shelving filter. More specifically, voice recordings from a microphone can be processed through a transfer function to map microphone and voice characteristics to haptic actuator characteristics. For instance, if a haptic actuator produces a particularly strong response at a first frequency, that frequency in the voice signals may be attenuated prior to inputting the signals to the haptic actuator. Similarly, if a haptic actuator produces a particularly weak response at a second frequency, that frequency in the voice signals may be increased or boosted prior to inputting the signals to the haptic actuator. Yet again, if a particular haptic frequency produces unpleasant sensations in the human hand, that frequency in the voice signals may be attenuated prior to input to the haptic actuator.

Proceeding to block 306, the API or other control component plays back the vocal sounds either in near-real time (i.e., as the voice audio is received from a computer simulation and played on an audio speaker) or at a later time in haptic format on the controller. In other words, the vocal audio is sent to the haptic generator to activate the haptic generator to produce tactile sensation in the controller 206. The voice audio also is played on a speaker according to demanded audio signals from the computer simulation.

It is to be understood that the voice audio sent to the haptic generator may be sent directly from audio input or it may be played on audio speakers can captured on one or more microphones, e.g., on the controller, console, or display in FIG. 2, and then sent to the haptic generator.

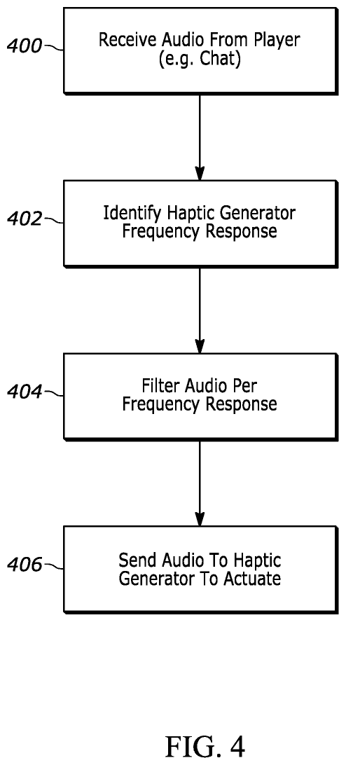

FIG. 4 illustrates that to enhance the sensory experience of voice audio that is received at block 400 from vocal sounds of a player of the simulation captured by a microphone or derived from game party chat for example, in some cases at a later time than the speech was spoken to enable reliving emotions and experiences, a computer game controller API or other control component accesses characteristics of the haptic generator 208 shown in FIG. 2 at block 402 in FIG. 4. If desired, at block 404 the voice audio may be filtered to conform to the characteristics of the haptic generator. For example, the voice audio can be optimized for the frequency response of the haptic generator, e.g., by removing sounds that won't vibrate well through use of an equalization filter or shelving filter.

Proceeding to block 406, the API or other control component plays back the vocal sounds either in near-real time (e.g., as the voice audio is received by a microphone) or at a later time in haptic format on the controller. In other words, the vocal audio is sent to the haptic generator to activate the haptic generator to produce tactile sensation in the controller 206. The voice audio also may be played on an audio speaker.

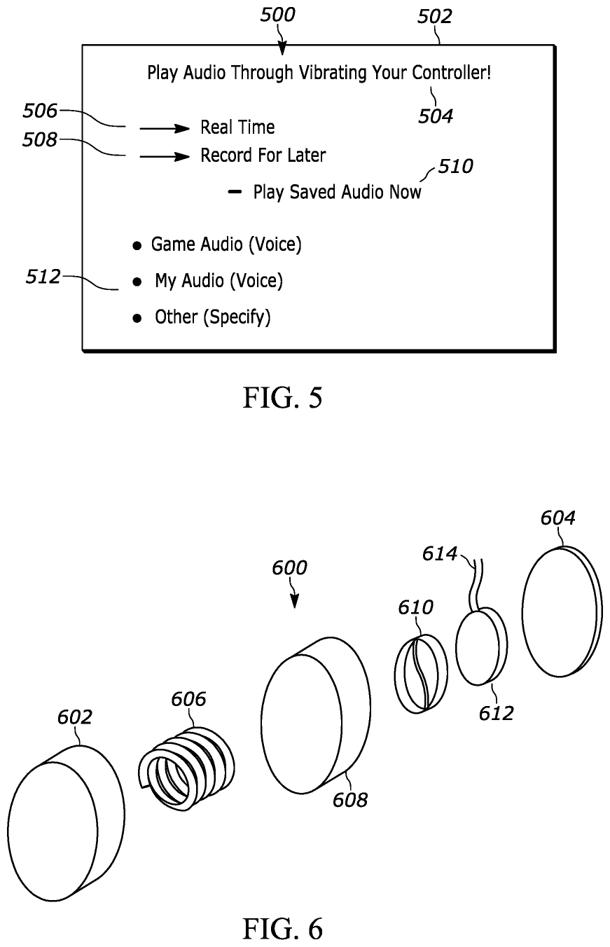

FIG. 5 illustrates a UI 500 that may be presented on a display 502 such as any display herein. A prompt 504 may be presented visually and/or audibly for the player to select to invoke the features described in FIGS. 3 and 4. Or, the logic described in FIGS. 3 and 4 may be invoked automatically by the system shown in FIG. 2.

Assuming player control, the UI 500 may also include a selector 506 to enable to player to select to use the voice audio to activate the haptic generator in real time, and a selector 508 to enable to player to select to use the voice audio to activate the haptic generator at a later time. A selector 510 may be provided to enable the player to select to play previously recorded voice audio on the haptic generator now.

Additionally, selectors 512 may be provided to allow the player to select the source of the voice audio to be used to activate the haptic generator. As discussed earlier, the voice audio may be dialog from a computer simulation, the player's own voice as recorded through a microphone, or other source such as voice derived from text-to-voice conversion of typed chat related to the computer simulation.

The haptic generator or generators 208 shown in FIG. 2 may be established by a linear actuator such as a linear resonance actuator (LRA). Such an actuator is shown in FIG. 6, it being understood that other haptic generator types may be used, e.g., rotational actuators or piezoelectric generators.

As shown in FIG. 6, an LRA 600 may include front and back covers 602, 604 that contain the remaining components shown in FIG. 6. A spring 606 may be disposed in compression between the front cover 602 and a disc-shaped movable mass 608. The movable mass 610 can include a magnetic component and a receptacle, referred to herein as a voice coil yoke, for receiving a hollow ring-shaped voice coil 610. An energizing component 612 such as a printed circuit board that is connected to other components in the controller 206 by electrical leads 614 provides the voice audio signals to the voice coil 610, exciting it to move the movable mass 608 and thus generate tactile signals in the controller 206 shown in FIG. 2 according to the voice audio signals.

While the particular embodiments are herein shown and described in detail, it is to be understood that the subject matter which is encompassed by the present invention is limited only by the claims.

What is claimed is:

1. An apparatus comprising:
at least one processor configured to:
receive voice audio related to play of at least one computer simulation; and
actuate at least one haptic generator using the voice audio.

2. The apparatus of claim 1, wherein the voice audio comprises dialog in the computer simulation.

3. The apparatus of claim 1, wherein the voice audio comprises chat of at least one player of the computer simulation.

4. The apparatus of claim 1, wherein the haptic generator comprises a linear actuator.

5. The apparatus of claim 4, wherein the linear actuator comprises a linear resonant actuator.

6. The apparatus of claim 5, wherein the linear resonant actuator comprises at least one voice coil coupled to at least one moving mass comprising at least one magnetic element.

7. The apparatus of claim 1, wherein the processor is configured to actuate the at least one haptic generator using the voice audio as the voice audio is played on at least one speaker.

8. The apparatus of claim 1, wherein the processor is configured to actuate the at least one haptic generator using the voice audio after the voice audio is played on at least one speaker.

9. A method to enhance the sensory experience of voice, comprising:
capturing vocal sounds related to a computer simulation; and
activating at least one haptic generator in at least one computer simulation component using the vocal sounds.

10. The method of claim 9, comprising activating the at least one haptic generator at a time subsequent to playing the computer simulation.

11. The method of claim 9, comprising activating the at least one haptic generator as the vocal sounds are played on at least one audio speaker.

12. The method of claim 9, comprising capturing the vocal sounds using at least one microphone.

13. The method of claim 9, comprising processing the vocal sounds using a computer game controller application programming interface (API) to send the vocal sounds to the haptic generator.

14. The method of claim 9, wherein the vocal sounds comprise computer game dialogue.

15. The method of claim 9, wherein the vocal sounds comprise computer game chat.

16. A device comprising:
at least one computer storage that is not a transitory signal and that comprises instructions executable by at least one processor to:
receive signals representing speech related to at least one computer simulation; and
use the signals to activate at least one haptic generator.

17. The device of claim 16, wherein the instructions are executable to:
process the signals to conform to characteristics of the haptic generator.

18. The device of claim 16, wherein the instructions are executable to:
optimize the signals for a frequency response of the haptic generator.

19. The device of claim 18, wherein the instructions are executable to:
remove portions of the signals through use of an equalization filter.

20. The device of claim 18, wherein the instructions are executable to:
remove portions of the signals through use of a shelving filter.
